(19) United States
(12) Patent Application Publication
(10) Pub. No.: US 2005/0237945 A1
(43) Pub. Date: Oct. 27, 2005

(54) Network comprising search functions that are integrated into communication components

(76) Inventors: Ralf Neuhaus, Lunen (DE); Rainer Uecker, Mulheim (DE)

Correspondence Address: Siemens Corporation;Intellectual Property Department, 170 Wood Avenue South, Iselin, NJ, 08830, US

(21) Appl. No.: 10/520,715

(22) PCT Filed: Jun. 6, 2003
(86) PCT No.: PCT/DE03/01900

§ 371 Date: Jun. 17, 2005

(30) Foreign Application Priority Data
Jul. 8, 2002 (DE) 10230684.2

(51) Int. Cl. H04L 12/28; H04L 12/66

(52) U.S. Cl. 370/254; 370/352

(57) ABSTRACT

The invention relates to a network, in which addresses are assigned to communication components, said addresses allowing the components to communicate with one another. Several communication components comprise integrated search functions for determining the addresses of resources that are installed in other communication components. To determine the addresses, each of said search functions sends a first search notification, as a consequence of which each communication component that has been contacted returns a hit response comprising its address. The search function subsequently sends a second search notification containing information concerning the desired resources to at least one of the communication components that have been determined, whereby a communication component that can provide one of the desired resources replies to the second search notification. The resources comprise communication services that can be used in the network and the reply to the second search notification contains specific information concerning the respective communication service. The communication components that reply to the second search notification also forward said second notification to other communication components.

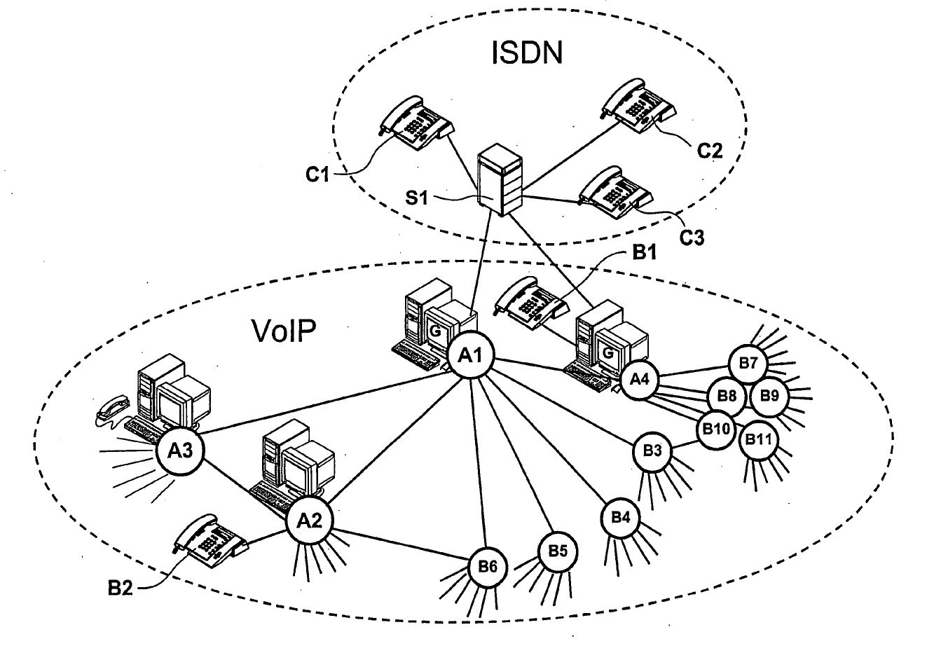

### CROSS REFERENCE TO RELATED APPLICATIONS

This application is the US National Stage of International Application No. PCT/DE2003/001900, filed Jun. 6, 2003 and claims the benefit thereof. The International Application claims the benefits of German application No. 10230684.2 filed Jul. 8, 2002, both applications are incorporated by reference herein in their entirety.

### FIELD OF THE INVENTION

The invention relates to a network comprising search functions that are integrated into communication components.

### SUMMARY OF THE INVENTION

In packet-switching networks (IP networks; IP=Internet Protocol) the components in the network communicate by sending and receiving addressed data packets. To communicate in the network, each component requires a separate network address. In addition, communication requires knowledge of the network address of the communication partner. Only then is direct communication possible, that is to say without the interposition of a further entity. The network addresses are either permanently associated with each component or else are assigned to the component dynamically, that is to say for a limited time, when the components are turned on. This allocation of the network addresses to the components is usually done by a server as the central entity in the network. A server of this type also provides the components in the network with the network addresses of other components for the purpose of interchanging data with them. Such devices for managing network addresses are frequently also used in communication networks which operate on the basis of the Internet protocol. These communication networks are referred to as voice-over IP (VOIP) networks in the literature.

VoIP networks contain not only the communication components used as communication terminals, that is to say telephones, telephony and multimedia PCs etc., but also communication components which have resources such as gateways. In this context, gateways are devices which connect the packet-switching IP network to a circuit-switching network, for example the ISDN, and thus actually allow communication links between communication components in the VOIP network and those in the ISDN. When a communication component in an IP network sets up a link to a telephone in an ISDN network, the communication component in the IP network requires the information about what position in the network has a suitable gateway available. In this case, the “position” does not or not just denote a geographical position, but rather primarily denotes the network address of that component in the network which makes the “gateway” resource available to other network components. In addition, the communication component which wants to set up the communication link requires further information about the use of the resource, that is to say for example details about the possible audio codec, address. formats, network port number, etc.

The addresses of the communication components which can be reached in the inherent network and the details about the usable resources in the network are either stored in each communication component or can be retrieved in a central server, the “gatekeeper”. In both cases, it is necessary to administrate these data, that is to say both to input them for the first time and to perform continual data maintenance in the event of alterations to the network structure or the communication components.

The Internet-published specification. “The Gnutella Protocol Specification V 0.4” discloses a method which communication components on the Internet can use to find other communication components in order to interchange files with them. In this case, the data interchange takes place not using a central server or gatekeeper but rather in direct communication between the communication components. Such networks, which, without a superordinate entity, provide direct data interchange between communication components, are also. called peer-to-peer networks, and the communication components, which comprise functionalities both from the “clients” and from the “servers” in known networks, are frequently called “servents” in the literature.

In the peer-to-peer network based on the Gnutella specification, each communication component—which are PCs in this case—holds a number of files ready for interchange with other communication components. In order to be able to interchange data, a searching communication component requires the network address of another communication component which holds the sought file ready for retrieval. To this end, the searching communication component first of all sends a first search message, the “ping”. The communication components which receive a “ping” search message of this type respond to the searching communication component with a hit response, the “pong”. This hit response contains the network address of the responding communication component and also the number of files provided by this communication component for interchange. In the next step, the searching network component sends a second search message “query” to a limited number of those communication components which have responded to the “ping” search message with a “pong”. This second search message contains the file name of the file which is being sought. If a component receives a second search message “query” and does not itself hold the sought file ready for interchange, this communication component forwards this second search message to other communication components in the network, whose addresses it has ascertained by means of a “ping” method which has already been carried out in the past, for example. If the communication component is able to provide the desired file for interchange, however, it responds to the second search message “query” with a second hit response “query hit”, which allows the searching communication component to initiate the file transfer using commands defined in the Internet protocol.

It has been found to be a drawback of the known methods that the use of resources requires the information about these resources and their addresses in the network to be recorded in one or more central computers (servers, gatekeepers).

These data need to be stored when each resource is started and maintained in the event of changes, which entails a high level of often manual involvement. In the time between the change of addresses and resources and the data maintenance it is additionally not possible to use the affected resource. The same applies when one of the central computers (servers) fails.

It is an object of the invention to reduce the administration involvement in networks.

This object is achieved by the claims.

The object is achieved by virtue of the resources comprising communication services which can be used in the network, with the response to the second search message containing respective specific information about the communication service, and by virtue of the communication components which respond to the second search message also forwarding the second search message to other communication components. As a result, the searching communication component is sent the addresses of a plurality or all of the communication components which provide the sought communication service.

The characterizing features of the dependent claims advantageously refine the arrangement further.

The number of search operations is reduced if the communication components can store the details about the resources of further communication components which (resources) can be used in the network.

If the second search message is used to ascertain the information stored in a communication component about the usable resources of further communication components, with the response to this search message comprising the addresses and the use-related details, the network load produced by the search operations is reduced.

The access to resources can be controlled by virtue of the communication components being able to be used to disable or enable access to individual or all inherent resources by other communication components.

If the communication components can send and/or respond to both first and second search messages, the resources which can be used in the network can be found particularly quickly.

Sought resources and communication services are also found reliably in widely branched networks by virtue of the search function of a communication component sending at least one first search message and continuing to send second search messages until a sought resource has been found in the network and the information transmitted in the response to one of the second search messages allows the use of the resource.

It is no longer necessary to manage subscriber directories containing the network addresses of the communication terminals if the addresses of communication components which (addresses) have been obtained from the hit response and from the response to second search messages can be used to set up communication links.

A plurality of resources found which are of the same type may have the respectively most suitable one selected from them if the response comprises the type and number of available services and also the type of the inherent network access, including bandwidth and availability, and the location information.

An exemplary embodiment of an inventive network having search functions integrated into communication components is described below with reference to the drawing. In this case, the single figure shows a schematic illustration of a packet-switching communication network which is connected to a circuit-switching communication network.

### BRIEF DESCRIPTION OF THE DRAWING

The sole FIGURE shows a schematic illustration of a packet-switching communication network which is connected to a circuit-switching communication network.

### DETAILED DESCRIPTION OF THE INVENTION

Communication components A1-A4, B1-B11 are connected to one another in the packet-switching communication network VOIP. The packet-switching network VOIP is meshed in a hybrid form comprising star-like and ring-like networking. In principle, any form of meshing is possible, so long as each communication component A1-A4, B1-B11 can interchange data with any other component A1-A4, B1-B11 directly or indirectly, that is to say with the interposition of other communication components A1-A4, B1-B11.

The circuit-switching network ISDN contains a communication installation S1 and communication terminals C1-C3. It goes without saying that the circuit-switching network ISDN can also contain a plurality of communication installations with an arbitrary number of communication terminals.

The communication components A1, A4 arranged in the packet-switching network VOIP are each equipped with a gateway function as a resource. This gateway function connects the packet-switching network VoIP to the circuit-switching network ISDN.

The communication component A3 is equipped with a telephony function. This function can be used to set up and use voice links to all voice terminals B1, B2 arranged in the packet-switching network VOIP and all other communication components A1-A4, B3-B11 equipped with a telephony function. The communication component A3 can also set up and use voice links to communication terminals C1-C3 which are arranged in the ISDN. To this end, the communication component A3 first needs to set up a connection to a gateway provided on the communication component A1 as a resource.

To set up a voice link, starting from the communication component A3 in the packet-switching network VOIP to the communication component C1 arranged in the circuit-switching network ISDN, the telephony function installed on the communication component A3 requires the address of the communication component A1 and also the access parameters and use-related information from the gateway provided on the communication component A1. Alternatively, the use of the gateway installed on the communication component A4 is possible.

The address of a communication component A1-A4, B1-B11 is in this case the network address (IP address) which is used to address the communication component A1-A4, B1-B1 itself. The resources provided on a communication component A1-A4, B1-B11 are distinguished using IP port numbers, which means that each resource is unambiguously addressable from the combination of the IP address and the IP port number.

To ascertain the address of the communication component A1, the telephony function of the communication component A3 sends a first search message to a number of further communication components A2, B6. Besides the address of the sending communication component A3, this first search message comprises the information that this communication component is searching for other communication components A1-A4, B1-B11 which support the search method being used for components and resources. Since the two addressed communication components A2, B6 support the search method, they each return a hit response containing their own address to the communication component A3. The communication component A3 then sends a second search message to all communication components A2, B6 which have responded to the first search message with a hit response. This second search message again comprises the address of the searching communication component A3, but this time including the information about what type of resource is being sought, namely a gateway to a circuit-switching network. Since the communication component A2 does not have a resource of the sought type “gateway”, it forwards the second search message to further, neighboring communication components A1, B3. The communication component B6 likewise has no resource of the sought type, which means that the communication component B6 also forwards the second search message to other communication components B5, B4 it knows which likewise support the search method which is being used.

The communication component A1 has a resource of the sought type “gateway”. It responds to the second search message by sending the searching communication component A3 a response message which, besides its own network address, comprises information about the resources it provides. This information includes details about the IP port number, the number of available channels, the transmission bandwidth of the channels, the transmission standards which can be used, the location, etc. This information is then used by the communication component A3 to set up a voice link to the communication terminal C1 via the gateway of the communication component A1 and the circuit-switching communication installation S1, provided that the use of this resource is enabled in the communication component A1.

Although the communication component Al has been able to respond positively to the second search message from the communication component A3, which was sent to it-by the communication component A2, with the details about the gateway installed on it, it nevertheless forwards the second search message to communication components A4, B7 which it knows which likewise support the search method. The communication component A4 also has a gateway to the circuit-switching network ISDN and therefore returns a data record containing its address and the information about the gateway to the originally searching communication component A3. The communication component A3 thus receives information about the two resources of the type “gateway” which have been found in the packet-switching network VOIP.

The information about the resources found in the packet-switching network VOIP are stored in the communication component A3. If, at a later time, another of the communication components A1-A4, B1-B11 requires a gateway to the circuit-switching network ISDN in order to set up a voice link and, in the course of the search method, sends a second search message to the communication component A3, the communication component A3 responds to the search message using the stored information, even though it, itself, does not have a resource of the desired type, but can nevertheless provide the addresses and the use-related information about such resources. To this end, the communication component A3 can both send and respond to first and second search messages.

Both each searching communication component A1-A4, B1-B11 and the other communication components A1-A4, B1-B11 addressed during the search, continue the operation of sending and responding to first and second search messages until at least one resource of the type which is being sought has been found. In this case, however, limiting the network load requires limits to be prescribed which limit both the number of communication components A1-A4, B1-B11 addressed by a first or a second search message and the number of times that a second search message which has not received a positive response is forwarded from one communication component A1-A4, B1-B11 to the next.

1-9. (canceled)

10. A network, comprising:
communication components having associated addresses, wherein
the communication components are adapted to communicate with one another by using the addresses, wherein
a first plurality of the communication components has resources, the resources comprising a communication service usable in the network, wherein
search functions are integrated in a second plurality of the communication components for ascertaining the addresses of such communication components having resources, wherein
each search function is adapted to send a first search message which prompts each communication component reached by the first search message to return a hit response containing its address, wherein
each search function is further adapted to send at least a second search message comprising information about required resources to at least one of the ascertained communication components, wherein
at least one of the ascertained communication components which is able to provide the required resources responds to the second search message, wherein
the response to the second search message contains information about the communication service, and wherein
the communication components responding to the second search message forward the second search message to other communication components.

11. The network as claimed in claim 10, wherein the communication components are adapted to store details about the resources of the communication components which can be used in the network.

12. The network as claimed in claim 10, wherein the second search message is designed to ascertain the information stored in a communication component about the usable resources of the communication components, wherein the response to this search message comprises the addresses and use-related details.

13. The network as claimed in claim 11, wherein the second search message is designed to ascertain the information stored in a communication component about the usable resources of the communication components, wherein the response to this search message comprises the addresses and use-related details.

14. The network as claimed in claim 10, wherein the communication components are adapted to disable or enable access to individual or all inherent resources of a communication component.

15. The network as claimed in claim 11, wherein the communication components are adapted to disable or enable access to individual or all inherent resources of a communication component.

16. The network as claimed in claim 12, wherein the communication components are adapted to disable or enable access to individual or all inherent resources of a communication component.

17. The network as claimed in claim 10, wherein the communication components are designed to respond to the first and the second search messages.

18. The network as claimed in claim 11, wherein the communication components are designed to respond to the first and the second search messages.

19. The network as claimed in claim 12, wherein the communication components are designed to respond to the first and the second search messages.

20. The network as claimed in claim 10, wherein the search function of a communication component is adapted such that it sends at least one first search message and continues to send second search messages until a sought resource has been found in the network and the information transmitted in the response to one of the second search messages allows the use of the resource.

21. The network as claimed in claim 11, wherein the search function of a communication component is adapted such that it sends at least one first search message and continues to send second search messages until a sought resource has been found in the network and the information transmitted in the response to one of the second search messages allows the use of the resource.

22. The network as claimed in claim 12, wherein the search function of a communication component is adapted such that it sends at least one first search message and continues to send second search messages until a sought resource has been found in the network and the information transmitted in the response to one of the second search messages allows the use of the resource.

23. The network as claimed in claim 10, wherein the addresses of communication components which have been obtained from the hit response and from the response to second search messages can be used to set up communication links.

24. The network as claimed in claim 11, wherein the addresses of communication components which have been obtained from the hit response and from the response to second search messages can be used to set up communication links.

25. The network as claimed in claim 12, wherein the addresses of communication components which have been obtained from the hit response and from the response to second search messages can be used to set up communication links.

26. The network as claimed in claim 10, wherein the response comprises a type and a number of available resources and/or available communication services and also a type of an inherent network access, including bandwidth and availability, and a location information.

27. The network as claimed in claim 11, wherein the response comprises a type and a number of available resources and/or available communication services and also a type of an inherent network access, including bandwidth and availability, and a location information.

28. A method for autonomously administrating a network having communication components which have associated addresses and which communicate with one another using these addresses, wherein some of the communication components have resources, the resources comprising a communication service which can be used in the network, the method comprising:
determining the addresses of communication components which have resources by using search functions integrated in some of the communication components, wherein each of the search functions determines the addresses by sending a first search message which prompts each communication component reached by the first message to return a hit response containing its address;
sending at least one second search message comprising information about required resources to at least one of the determined communication components by the search function, wherein at least one of the communication components which is able to provide the required resources responds to the second search message, wherein the response to the second search message contains specific information about the communication service; and
forwarding the second search message to other communication components by the communication components which respond to the second search message.
